(19) United States
(12) Patent Application Publication
(10) Pub. No.: US 2020/0018001 A1
(43) Pub. Date: Jan. 16, 2020

(54) LAMINATED NONWOVEN FABRIC SHEET

(71) Applicants: JNC CORPORATION, Tokyo (JP); JNC FIBERS CORPORATION, TOKYO (JP)

(72) Inventor: MITSURU KOJIMA, Shiga (JP)

(73) Assignees: JNC CORPORATION, Tokyo (JP); JNC FIBERS CORPORATION, TOKYO (JP)

(21) Appl. No.: 16/462,245

(22) PCT Filed: Nov. 9, 2017
(86) PCT No.: PCT/JP2017/040368

§ 371 Date: Jul. 29, 2019

(30) Foreign Application Priority Data
Nov. 21, 2016 (JP) 2016-226101

(51) Int. Cl. D04H 1/4374; B32B 5/26; B32B 5/02; D04H 1/425; D04H 1/492; D04H 1/56; A62B 18/02

(52) U.S. Cl. CPC D04H 1/4374; B32B 5/26; B32B 5/022; D04H 1/425; D10B 2505/04; D04H 1/56; A62B 18/02; B32B 2571/00; D10B 2501/042; D04H 1/492

(57) ABSTRACT

The invention provides a laminated nonwoven fabric sheet formed by uniting an ultrafine fiber layer and a hydrophilic short fiber layer, in which the hydrophilic short fiber layer is laminated on one surface or both surfaces of the ultrafine fiber layer, the ultrafine fiber layer is formed by combining 20 to 80% by mass of thermoplastic resin fibers (A) and 80 to 20% by mass of elastomer resin fibers (B) that melt or soften at a temperature lower than a temperature of thermoplastic resin fibers (A), and the ultrafine fiber layer includes a hindered amine compound, the laminated nonwoven fabric sheet is subjected to electret processing, and 10% stretch strength in one direction is different from 10% stretch strength in a direction perpendicular to the one direction.

### TECHNICAL FIELD

The invention relates to a laminated nonwoven fabric sheet in which a plurality of nonwoven fabrics are laminated and united.

### BACKGROUND ART

A nonwoven fabric sheet has been so far used for a mask for removing fine dust such as pollen and particulate matter. The mask is required to collect fine dust with high efficiency, and simultaneously have low inhalation resistance upon gas passing so as to prevent a wearer from feeling respiratory discomfort.

For example, Patent literature No. 1 discloses a pleat-type sanitary mask having at least three layers of innermost layer/filter layer/outermost layer, and a material in which a sealing material is arranged in a part in touch with cheek of a person in a peripheral portion of the innermost layer, in which at least one of the inner layer and the outermost layer has flexural rigidity in a specific range, and the filter layer has pressure loss in a specific range. The mask of Patent literature No. 1 improves protection by the mask by eliminating a gap between the mask and the face by the sealing material in the peripheral portion of the mask. Moreover, shape retention of the mask is improved by increasing rigidity of a nonwoven fabric in the innermost layer or the outermost layer.

Patent literature No. 2 discloses an art using an elastic nonwoven fabric containing a specific olefin-based copolymer component and a specific thermoplastic elastomer component as an elastic member of a disposable mask made of a nonwoven fabric. The invention of Patent literature No. 2 is applied to improve fitting performance by using the nonwoven fabric containing the elastomer component to disclose an art of preparing the nonwoven fabric by extruding, from a spinneret, a material prepared by previously blending the olefin-based copolymer component and the elastomer component, and melt-kneading the resulting mixture at a temperature equal to or higher than a softening point thereof.

On the other hand, a nonwoven fabric subjected to electret processing is publicly known for improving dust collection performance. Patent literature No. 3 discloses a laminated nonwoven fabric that is a filter material for a medical mask or an industrial mask, and a laminated electret nonwoven fabric subjected to electret processing after laminating, at least on one surface of nonwoven fabric A having a mean fiber diameter of 0.1 to 15 micrometers, and obtained by combining two kinds of fibers having different melting points, one layer or a plurality of layers of nonwoven fabric B having a mean fiber diameter of 10 micrometers to 100 micrometers, and formed of fibers having the mean fiber diameter larger than the mean fiber diameter of fibers constituting nonwoven fabric A. In the invention of Patent literature No. 3, the layers can be laminated without using an adhesive component by combining fibers having a relatively low melting point into nonwoven fabric A, whereby a filter material in which pressure loss is suppressed can be obtained.

### REFERENCE LIST

### Patent Literature

Patent literature No. 1: JP 2014-223227 A.

Patent literature No. 2: JP 2003-180852 A.

Patent literature No. 3: WO 2011/004969 A.

### SUMMARY OF INVENTION

### Technical Problem

However, according to a mask of Patent literature No. 1, a sealing material is arranged so as to fill a gap between the mask and the face. Meanwhile, the mask is not arranged in good order depending on a shape of user's face, and therefore a load has been applied to a part of skin, or a sufficient sealing effect has been unable to be obtained in several cases. Moreover, a mask of Patent literature No. 2 is the mask of a type according to which a mouth covering portion and an ear-fitting portion are integrally formed from one sheet of nonwoven fabric, and the nonwoven fabric is required to have predetermined strength and shape retention, and therefore fitting performance to skin has not always been sufficient, and also collection of fine dust with high accuracy has been difficult. Further, according to a filter material of Patent literature No. 3, a spun-bond nonwoven fabric mainly containing polyester and having good shape retention is used, and therefore if the material is formed into a mask, the mask has lacked in flexibility in several cases, and therefore has been not always sufficient in texture or fitting performance.

As described above, a superior material has been required as the mask satisfying both dust collection performance and permeability (low pressure loss), and being excellent in fitting performance and flexibility. In view of the actual situation, an object of the invention is to provide a nonwoven fabric sheet that can be used as a filter material of a mask, and a material satisfying both high dust collection performance and low pressure loss, and further being flexible and excellent in followability to skin.

### Solution to Problem

The present inventors have diligently continued to conduct research for solving the problems described above. As a result, the present inventors have found that followability to movement of skin is improved by providing a nonwoven fabric with somewhat stretchability. Then, the present inventors have found that, as the nonwoven fabric, a material being a nonwoven fabric sheet in which a hydrophilic short fiber layer having stretchability advantageous at least in one direction and an ultrafine fiber layer including a thermoplastic resin and an elastomer resin are laminated and united, and the material subjected to electret processing has high dust collection performance and low pressure loss, and is excellent in followability to skin and texture, and have completed the invention.

More specifically, the invention has structure as described below.

Item 1. A laminated nonwoven fabric sheet formed by uniting an ultrafine fiber layer and a hydrophilic short fiber layer, wherein

the hydrophilic short fiber layer is laminated on one surface or both surfaces of the ultrafine fiber layer;

the ultrafine fiber layer is formed by combining 20 to 80% by mass of thermoplastic resin fibers (A) and 80 to 20% by mass of elastomer resin fibers (B) that melt or soften at a temperature lower than a temperature of thermoplastic resin (A); and the ultrafine fiber layer includes a hindered amine compound;

the laminated nonwoven fabric sheet is subjected to electret processing; and

10% stretch strength in one direction is different from 10% stretch strength in a direction perpendicular to the one direction.

Item 2. The laminated nonwoven fabric sheet according to item 1, wherein the ultrafine fiber layer and the hydrophilic short fiber layer are united by partial thermocompression bonding, 10% stretch strength in one direction is 3 N/25 mm or less and 50% stretch strength is 10 N/25 mm or less, and 10% stretch strength in the direction perpendicular to the one direction is 15 N/25 mm or more.

Item 3. The laminated nonwoven fabric sheet according to item 1 or 2, wherein discontinuous and regular concave portions are formed on a surface of the laminated nonwoven fabric sheet, and a total area of the concave portions on the surface is in the range of 3 to 40%; and

in a sheet thickness direction of the concave portions, the elastomer resin fibers (B) in the ultrafine fiber layer and fibers constituting the hydrophilic short fiber layer are bonded; and the hydrophilic short fiber layer and the previous ultrafine fiber layer are united.

Item 4. The laminated nonwoven fabric sheet according to any one of items 1 to 3, wherein the hydrophilic short fiber layer is a layer including at least 30% by mass of short fibers of cotton, rayon, cupra, or pulp, or two or more kinds thereof.

Item 5. The laminated nonwoven fabric sheet according to any one of items 1 to 4, wherein the hydrophilic short fiber layer is a spunlace nonwoven fabric or a wet paper-making web.

Item 6. The laminated nonwoven fabric sheet according to any one of items 1 to 5, wherein the ultrafine fiber layer is a melt-blown nonwoven fabric formed by randomly accumulating long fibers.

Item 7. A mask, containing the laminated nonwoven fabric sheet according to any one of items 1 to 6.

### Advantageous Effects of Invention

A laminated nonwoven fabric sheet of the invention satisfies both high dust collection and low pressure loss, is flexible and excellent in followability to skin, and can be preferably used as a filter material of a mask. Moreover, the laminated nonwoven fabric sheet of the invention is excellent in flexibility and satisfactory in texture and soft in skin contact, and therefore is excellent in wearing feeing when the laminated nonwoven fabric sheet is used as the mask.

### BRIEF DESCRIPTION OF DRAWINGS

FIG. 1 is an electron photomicrograph of an ultrafine fiber layer contained in a laminated nonwoven fabric sheet in Examples of the invention.

### DESCRIPTION OF EMBODIMENTS

The invention will be described in detail below.

### Laminated Nonwoven Fabric Sheet

A laminated nonwoven fabric sheet of the invention is formed by laminating and uniting at least two kinds of layers of an ultrafine fiber layer and a hydrophilic short fiber layer. The hydrophilic short fiber layer is laminated on one surface or both surfaces of the ultrafine fiber layer, and a different layer may be further laminated thereon according to a purpose. The ultrafine fiber layer and the hydrophilic short fiber layer are preferably adjacent to each other, but when the sheet further has the different layer, the sheet may be in a form in which the different layer exists between the ultrafine fiber layer and the hydrophilic short fiber layer, and the ultrafine fibers and the hydrophilic short fiber layer are not adjacent to each other. The ultrafine fiber layer mainly functions as a collection layer, and the hydrophilic short fiber layer is a flexible cover material, and also functions as a reinforcement layer. When the laminated nonwoven fabric sheet is formed as a mask, either of the ultrafine fiber layer or the hydrophilic short fiber layer may be arranged on a side in contact with skin of a wearer, and can be appropriately arranged according to the purpose.

A method of laminating and uniting the ultrafine fiber layer and the hydrophilic short fiber layer is not particularly limited, and in order to keep permeability, both the layers are preferably united by thermocompression bonding, and no use of an adhesive such as latex is preferred. The thermocompression bonding is a processing method by heat and pressure, and therefore has an advantage of capability of processing at a temperature lower than a melting point of an elastomer resin to be welded. More specifically, fibers other than the fibers in a thermocompression bonding part are not fused by heat, and therefore thermocompression bonding is preferably used. An area per one point adhesion portion subjected to thermocompression bonding is not particularly limited, and can be adjusted to 0.04 to 10 mm², for example. When thermocompression bonding is performed, a whole surface may be subjected to thermocompression bonding, but only a part is preferably partially subjected to thermocompression bonding. A proportion of the part to be subjected to thermocompression bonding can be adjusted to 3 to 40% of a surface of the laminated nonwoven fabric sheet, and is further preferably 4 to 25% thereof. If an area percentage of the thermocompression bonding part less than 3%, insufficiency of peeling strength of the laminated nonwoven fabric is concerned, and if the area percentage is significantly more than 40%, texture may be adversely affected. A specific shape and arrangement of the thermocompression bonding part are not particularly limited, and may be processed in a form in which shapes such as rounds and squares are discontinuously and regularly arranged, for example. The thermocompression bonding part is represented as a concave portion on the surface of the nonwoven fabric sheet, and in the concave portion, elastomer resin fibers contained in the ultrafine fiber layer and the fibers of the hydrophilic short fiber layer are welded and bonded with each other in a sheet thickness direction.

The laminated nonwoven fabric sheet of the invention has characteristics of having stretchability, and particularly preferably has stretchability advantageous in a specific direction. Specifically, 10% stretch strength in one direction of the laminated nonwoven fabric sheet and 10% stretch strength in a direction perpendicular to the one direction are preferably different from each other. The “10% stretch strength” means stress when the laminated nonwoven fabric sheet is stretched by 10% from a natural length thereof. In a similar manner, the “50% stretch strength” means stress when the laminated nonwoven fabric sheet is stretched by 50% from the natural length.

A specific measuring method for stretch strength will be described later.

The stretch strength of the laminated nonwoven fabric sheet can be appropriately set according to the purpose, and for example, 10% stretch strength in one direction is preferably 3 N/25 mm or less and 50% stretch strength in one direction is preferably 10 N/25 mm or less, and 10% stretch strength in the direction perpendicular to the one direction is preferably 15 N/25 mm or more. More specifically, such a material is preferred in which the stretch strength in one direction is relatively low (stretchability is high), and the stretch strength in the direction perpendicular thereto is high (stretchability is low). If the 10% stretch strength in one direction is 3 N/25 mm or less and the 50% stretch strength is 10 N/25 mm or less, the sheet can provide a wearing site on sensitive and delicate skin with a friendly and significantly comfortable wearing feeling, for example. Moreover, if the 10% stretch strength in the direction perpendicular thereto is 15 N/25 mm or more, the nonwoven fabric is hardly stretched, and therefore during production of a product in a processing line, for example, upon pulling out the nonwoven fabric from a roll form, the sheet can be produced without being influenced by a change in width of the nonwoven fabric, and therefore the sheet can be produced at a high speed. Therefore, such a case is preferred. When the laminated nonwoven fabric sheet is used in the mask, the sheet in a direction of high stretchability is used in a vertical direction, whereby the mask is not only excellent in fitting performance when the wearer stands still, but also easily follows the skin even during movement such as moving a mouth, and therefore such a case is preferred.

A lower limit of the 10% stretch strength and the 50% stretch strength in the one direction is not particularly limited, but is preferably 1 N/25 mm or more in view of capability of keeping flexibility while suppressing curving, wrinkling or the like in traveling during production. Moreover, an upper limit of the 10% stretch strength in the direction perpendicular to the one direction is not particularly limited, either, but is preferably 30 N/25 mm or less in consideration of a reasonable embodiment.

In addition, in the present description, terms “one direction” and “a direction perpendicular to the one direction” mean any one direction and the direction perpendicular thereto in a plane of the nonwoven fabric sheet, and may be any direction in the plane of the nonwoven fabric sheet, and typically a CD direction of the nonwoven fabric sheet may be applied as “one direction,” and an MD direction may be applied as “the direction perpendicular to the one direction” in the same manner.

A basis weight of the laminated nonwoven fabric sheet should be selected according to the purpose, and is not particularly limited, but is preferably about 20 to about 150 g/m² when the sheet is used in the mask, and further preferably 30 to 120 g/m², for example. When the sheet is used in the mask, the range described above is preferred in view of a degree of dust collection and permeability to be required.

### Ultrafine Fiber Layer

The ultrafine fiber layer contained in the laminated nonwoven fabric sheet according to the invention is formed by combining 20 to 80% by mass of thermoplastic resin fibers (A) and 80 to 20% by mass of elastomer resin fibers (B) that melt or soften at a temperature lower than the temperature of thermoplastic resin (A). In addition, in the present description, a term “combining fibers” means a state in which at least two kinds of fibers are uniformly mixed to constitute the nonwoven fabric.

When a melting point of thermoplastic resin fibers (A) is taken as a (° C.) and a melting point of elastomer resin fibers (B) is taken as b (° C.), a difference: a-b is preferably 20 to 150° C., and further preferably 30 to 120° C. When the difference: a-b is 20° C. or more, and when the ultrafine fiber layer and the hydrophilic short fiber layer are laminated, both the layers can be united without melting thermoplastic resin fibers (A) having a higher melting point. Thus, thermoplastic resin fibers (A) can keep a fiber form to maintain sufficient permeability. Moreover, in order to uniformly combine the fibers, thermoplastic resin (A) and elastomer resin (B) are preferably spun from an identical spinneret, and in the above case, if the melting points of resins are significantly different from each other, spinnability tends to become difficult to be secured. If the difference: a-b is 150° C. or less, sufficient spinnability is secured.

The ultrafine fiber layer is not limited in a method of production as long as thermoplastic resin fibers (A) and elastomer resin fibers (B) that melt or soften at the temperature lower than the temperature of thermoplastic resin (A) are combined. Moreover, fibers other than thermoplastic resin (A) and elastomer resin fibers (B) may be combined in the ultrafine fiber layer within the range in which advantageous effects of the invention are not adversely affected.

The ultrafine fiber layer is preferably a layer of a nonwoven fabric obtained by a melt-blown method in which the layer is formed by randomly accumulating long fibers. Typically, the ultrafine fiber layer is obtained as a combined nonwoven fabric by independently melting and extruding thermoplastic resin (A) and elastomer resin (B) having a difference of 20° C. to 150° C. in the melting points to spin the resulting material from a combined melt-blown spinneret, and further blow spinning the resulting material as an ultrafine fiber flow by high-temperature and high-speed gas to collect the resulting material in a collecting device. Specific examples of the combined melt-blown spinneret include a melt-blown spinneret in which a plurality of different fiber component spinning holes are alternately arranged in one row in multiple holes.

Thermoplastic resin (A) is not particularly limited as long as the melting point thereof is higher than the melting point of elastomer resin (B), and the thermoplastic resin is a spinnable thermoplastic resin. For example, such a material can be used as polyolefins including polypropylene, high density polyethylene, low density polyethylene, linear low density polyethylene, a copolymer or a terpolymer of propylene with other olefins, polyamides, polyesters including polyethylene terephthalate, polybutylene terephthalate, low-melting point polyester prepared by copolymerizing diol and terephthalic acid, isophthalic acid or the like, and a polyester elastomer, a fluorocarbon resin, and a mixture of the resins described above. Above all, a material mainly containing polyolefin is preferred in view of particularly developing electret performance, and further among the polyolefins, a polypropylene-based resin which is excellent in heat resistance and from which fine fibers are easily spun. Moreover, other components may be copolymerized within the range in which properties of the polymer are not adversely affected. As the melting point of thermoplastic resin (A), a material having a melting point of 80 to 270° C. can be used, for example.

Specific examples of elastomer resin (B) that melts or softens at the temperature lower than the temperature of thermoplastic resin (A) include a polyolefin elastomer, a polystyrene elastomer, a polyester elastomer, a polyamide elastomer and a polyurethane elastomer. In particular, a polyolefin elastomer from which fine fibers are easily spun is preferred, and other components may be copolymerized within the range in which the properties of the polymer are not adversely affected. A melting point of elastomer resin (B) is 60 to 120° C., for example, and a material having a melting point lower than the melting point of thermoplastic resin (A) is used.

Examples of the polyolefin elastomer described above include a random copolymer of olefin monomers. The term “random copolymer of the polyolefin elastomer” means a copolymer of a monomer that is a hydrocarbon having a double bond and is represented by CₙH₂ₙ (n is an integer of 2 or more, and an upper limit thereof is not particularly limited, but n is preferably 10 or less), such as ethylene, propylene or butene, with at least one kind of monomer other than the monomer described above, and is a random copolymer in which the monomers are particularly aligned at random.

The random copolymer described above is preferably a copolymer of ethylene with an olefin having 3 to 10 carbons, or a copolymer of propylene with an olefin having 4 to 10 carbons, and further preferably a copolymer composed of ethylene and an olefin having 3 to 10 carbons. Specific examples of the olefin having 3 to 10 carbons include propylene, 1-butene, 3-methyl-1-butene, 4-methyl-1-butene, 1-pentene, 1-hexene, 4-methyl-1-pentene, 1-heptene, 1-octene, 1-nonene and 1-decene. Among the olefins described above, 1-butene, 1-pentene, 1-hexene or 1-octene is particularly preferred. In particular, the olefins can be used in one kind alone or in combination of two or more kinds. An ethylene-olefin copolymer such as an ethylene-octene copolymer and an ethylene-butene copolymer in which the above-described materials are combined is preferred. Moreover, a molecular weight distribution (Mw/Mn) of the copolymer of ethylene with the olefin having 3 to 10 carbons or the copolymer of propylene with the olefin having 4 to 10 carbons used in the invention is preferably 1.5 to 4 in view of spinnability. Specific examples of a commercially available product of such a polyolefin copolymer elastomer include “ENGAGE” (trade name, made by The Dow Chemical Company) and “Vistamax” (trade name, made by Exxon Mobil Corporation). Moreover, the polyolefin copolymer used in the invention may be a copolymer produced by using a metallocene catalyst. In addition, the polyolefin elastomer described above also includes a terpolymer in which a crosslinking diene monomer is added to olefins, and specific examples thereof include ethylene-propylene-diene rubber and ethylene-butene-diene rubber.

A mass ratio of thermoplastic resin fibers (A) to elastomer resin fibers (B) is in the range of 20 to 80% by mass of thermoplastic resin fibers (A) and 80 to 20% by mass of elastomer resin fibers (B), and further preferably in the range of 30 to 70% by mass of thermoplastic resin fibers (A) and 70 to 30% by mass of elastomer resin fibers (B). Elastomer resin fibers (B) are melted by heating, and function as an adhesive component for bonding with other components, and also functions as a stretching component for providing stretchability of the nonwoven fabric sheet. Meanwhile, if a proportion of elastomer resin fibers (B) in the ultrafine fiber layer is 20% by mass or more, interlayer adhesion force between the ultrafine fiber layer and the hydrophilic short fiber layer is sufficiently strong, and no peeling of the layers is caused during mask formation, pleating or the like, and stretchability can be developed in the laminated nonwoven fabric sheet. Moreover, if the mass ratio of elastomer resin fibers (B) in the ultrafine fiber layer is 80% by mass or less, a melting amount of elastomer resin fibers (B) that is the adhesive component is kept in a suitable range, and therefore no increase of pressure loss is caused. Elastomeric resin fibers (B) is preferably in the range of 30 to 70% by mass in the ultrafine fiber layer in view of a balance between strength of the laminated nonwoven fabric sheet and filter performance.

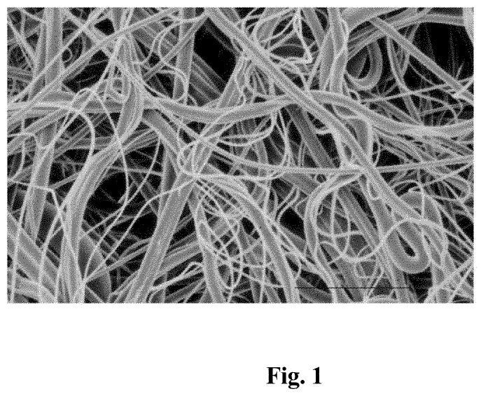

Fiber diameters of thermoplastic resin fibers (A) and elastomer resin fibers (B) both constituting the ultrafine fiber layer may be the same with or different from each other, and a mean fiber diameter of thermoplastic resin fibers (A) is 0.5 to 10 μm, and preferably 1 to 5 μm, and a mean fiber diameter of elastomer resin fibers (B) is 2 to 20 μm, and preferably 4 to 18 μm. In addition, in the present description, the term “ultrafine fiber” refers to a fiber having a mean fiber diameter of 15 μm or less, and a nonwoven fabric having both filter performance and flexibility can be obtained by forming a nonwoven fabric layer with ultrafine fibers having such a range. FIG. 1 is an electron micrograph showing an example of an ultrafine fiber layer, and shows that thermoplastic resin fibers (A) (fine fibers) and elastomer resin fibers (B) (thick fibers) are combined. A scale bar in the photograph shows 100 μm.

Moreover, the ultrafine fiber layer includes at least one kind selected from the group of hindered amine-based compounds for the purpose of improving weather resistance and the electret performance. Specific examples of the hindered amine-based compound include poly[6-(1,1,3,3-tetramethylbutyl)imino-1,3,5-triazine-2,4-diyl)((2,2,6,6-tetramethyl-4-piperidyl)imino)hexamethylene((2,2,6,6-tetramethyl-4-piperidyl)imino)] (“Chimassorb 944 FDL,” made by BASF Japan Ltd.), butanedioic acid, dimethylester, polymer with 4-hydroxy-2,2,6,6-tetramethyl-1-piperidine ethanol (“Tinuvin 622 FS,” made by BASF Japan Ltd.) and 2-(3,5-di-t-butyl-4-hydroxybenzyl)-2-n-butylmalonic acid bis(1,2,2,6,6-pentamethyl-4-piperidyl) (“Tinuvin 144,” made by BASF Japan Ltd.).

A content of the hindered amine-based compound is not particularly limited, and is preferably in the range of 0.1 to 10% by mass, and further preferably 0.5 to 5% by mass, based on the resin of the ultrafine fiber layer. If an amount of addition is 0.1% by mass or more, an effect of improving the electret performance can be obtained. Moreover, if the amount of addition is 10% by mass or less, satisfactory spinnability can be obtained, and such addition is advantageous also in terms of cost. The hindered amine-based compound can be incorporated into the ultrafine fiber layer by previously blending the compound in either of thermoplastic resin (A) or elastomer resin (B), and by spinning the resulting material.

Moreover, in a thermoplastic resin that constitutes thermoplastic resin fibers (A) and elastomer resin fibers (B), an antioxidant, a light stabilizer, an ultraviolet absorber, a neutralizer, a nucleating agent, an epoxy stabilizer, a lubricant, an antibacterial agent, a flame retardant, a pigment, a plasticizer, and any other thermoplastic resin or the like can be added in the range in which advantageous effects of the invention are not adversely affected. Moreover, a cycloolefin copolymer can be added thereto for the purpose of improving heat resistance and the electret performance.

### Hydrophilic Short Fiber Layer

In the hydrophilic short fiber layer contained in the laminated nonwoven fabric sheet according to the invention, a length of short fibers constituting the hydrophilic short fiber layer is not particularly limited, and is preferably 2 to 100 mm. As the fibers constituting the hydrophilic short fiber layer, short fibers having a length ordinarily used can be used according to a specific technique upon preparing the fiber layer, for example, a form of a carded web, an air-laid web and a wet paper-making web. When a hydrophilic fiber layer is formed of long fibers or continuous fibers, the layer is hard to have stretchability at a degree capable of following the stretchability caused by the elastomer fibers in the ultrafine fiber layer to be united. Meanwhile, in the invention, the stretchability of the ultrafine fiber layer can be reflected on the laminated nonwoven fabric sheet as a whole by composing the hydrophilic fiber layer of the short fibers.

As the short fibers constituting the hydrophilic short fiber layer, cellulose fibers of cotton, hemp or the like, semi-synthetic fibers obtained using wool, silk, rayon, cupra, pulp and cellulose, a material prepared by applying hydrophilization treatment to synthetic fibers or the like can be used, and two or more kinds thereof may be used. A preferred material in view of hydrophilicity is cotton, rayon, cupra or pulp.

When the sheet is used as the mask, for example, the hydrophilic short fiber layer includes the hydrophilic short fibers described above preferably by 30% by mass or more, and further preferably by 50% by mass or more in order to absorb moisture around the mouth and caused by exhalation to reduce a discomfort feeling of the wearer. Moreover, in the hydrophilic short fiber layer, fibers other than the hydrophilic short fibers described above may be mixed in the range not more than 70% by mass. In particular, when the fibers other than the hydrophilic short fibers are included in the hydrophilic short fiber layer in the range of 0 to 50% by mass, flexibility can be maintained while retaining mechanical strength or elongation of the hydrophilic short fiber layer in a suitable level, and therefore such a case is further preferred. Specific examples of the fibers to be mixed include water-repellent synthetic fibers such as fibers obtained using polyester, polyolefin or polyamide, or conjugate fibers in combination of two or more kinds thereof.

A cross-sectional shape of the fibers contained in the hydrophilic short fiber layer is not particularly limited, and specific examples thereof can include a round cross-section, a flat cross-section, a profile cross-section and a hollow cross-section. When the cross-sectional shape of the fibers contained in the hydrophilic fiber layer has the round cross-section, a fiber diameter thereof is preferably in the range of more than 15 μm and 50 μm or less. Moreover, a basis weight of the hydrophilic short fiber layer is preferably 10 to 100 g/m², and further preferably 20 to 80 g/m², when the laminated nonwoven fabric sheet is used in the mask. If the basis weight of the hydrophilic short fiber layer is 10 g/m² or more, such a case is preferred in view of obtaining stretchability and flexibility, and if the basis weight of the hydrophilic short fiber layer is 100 g/m² or less, such a case is preferred in view of suppressing product cost and obtaining a compact laminated nonwoven fabric sheet.

Moreover, the hydrophilic short fiber layer preferably has stretchability at least in one direction. Specific examples of such a fiber layer include a carded web formed by aligning short fibers in one direction, an air-laid web or a wet paper-making web in which short fibers are randomly accumulated, and a nonwoven fabric obtained by three-dimensionally entangling the fibers by needle punch or spunlace (hydroentangling) or the like. A wet paper-making web or a spunlace nonwoven fabric is preferred. In the invention, the spunlace nonwoven fabric obtained by applying hydroentangling treatment to the carded web formed by aligning the short fibers in one direction, thereby three-dimensionally entangling the fibers has a particularly satisfactory balance between mechanical strength and flexibility, and therefore is preferred. In the invention, the laminated nonwoven fabric sheet having high stretchability in one direction can be obtained by adopting the nonwoven fabric having stretchability advantageous in a specific direction as the hydrophilic short fiber layer.

### Electret Processing

The laminated nonwoven fabric sheet of the invention is subjected to electret processing. “Electret processing” means processing of giving electric charge for the laminated nonwoven fabric sheet by performing electret processing such as a thermal electret method in which the electric charge is applied under a heating atmosphere at a temperature at which a low-melting point component of the fibers is not melted, and a corona discharge method in which the electric charge is applied by corona discharge. Collection performance of the nonwoven fabric sheet can be particularly improved by electret processing. However, electret processing method is not limited thereto. In addition, whether or not the nonwoven fabric sheet is subjected to electret processing can be confirmed by performing static elimination treatment of the laminated nonwoven fabric sheet, thereby confirming a difference in a collection percentage of the nonwoven fabric sheet before and after the static elimination treatment, for example. The static elimination treatment can be applied by an IPA solution immersion method or an IPA saturated vapor exposure method, for example. The IPA solution immersion method is performed by immersing the nonwoven fabric sheet in an isopropyl alcohol (IPA) solution for 2 minutes, taking out the resulting material, and then drying the material in air for 24 hours. The IPA saturated vapor exposure method is performed by exposing the nonwoven fabric sheet to an IPA saturated vapor atmosphere at a temperature of 15 to 30° C. for 24 hours or more.

### Method of Producing Laminated Nonwoven Fabric Sheet

The method of producing the laminated nonwoven fabric sheet according to the invention is not particularly limited, and the sheet can be produced according to the method described below, for example.

The ultrafine fiber layer can be typically produced by the melt-blown method in which the long fibers are randomly accumulated. Thermoplastic resin fibers (A) and elastomer resin fibers (B) that constitute the ultrafine fiber layer may be mixed after the fibers are produced, individually. However, the ultrafine fiber layer is preferably produced by a method of simultaneously spinning the fibers by the melt-blown method using so-called a combining nozzle prepared by alternately arranging, in one nozzle, spinning holes for outputting different types of fibers. According to the method described above, the ultrafine fiber layer in which thermoplastic resin fibers (A) and elastomer resin fibers (B) are significantly uniformly and randomly accumulated with each other can be obtained. If elastomeric resin fibers (B) are uniformly and randomly accumulated or mixed in the ultrafine fiber layer, high-level flexibility or stretchability can be obtained, and therefore such a case is preferred.

With regard to the combining nozzle, structure thereof is not limited as long as different kinds of fibers can be simultaneously spun, and uniformly and randomly accumulated. As the combining nozzle, such a nozzle can be preferably used in which spinning holes from which different kinds of resins flow out are alternately arranged in one row in one nozzle. Moreover, specific examples of another form can include a method of combining fibers with each other by spinning different resins from individual nozzles by using a device in which a plurality of nozzles having only spinning holes from which one resin flows out are arranged in a moving direction of an accumulation conveyor, and by performing entangling treatment of the resulting web laminate by needle punch or the like. In view of accompanying no posttreatment, the former nozzle is preferably used in which the spinning holes from which different kinds of resins flow out are alternately arranged in one row in one nozzle.

A basis weight of the ultrafine fiber layer can be arbitrarily controlled by adjusting a speed of the accumulation conveyor. Moreover, as a gas upon performing blow spinning, an inert gas such as a nitrogen gas or air is ordinarily used. A temperature of the gas is about 200 to about 500° C., and preferably about 250 to about 450° C., and a pressure is about 0.1 to about 6.0 kgf/cm² (about 98 to about 588 KPa), and preferably about 0.2 to about 5.5 kgf/cm² (about 196 to about 539 KPa). Spinning conditions therefor are appropriately set according to physical properties of the resin to be used or a combination thereof, an objective fiber diameter, the device such as the spinneret or the like.

The hydrophilic short fiber layer contained in the laminated nonwoven fabric sheet according to the invention is preferably a spunlace nonwoven fabric or a wet paper-making web. The spunlace nonwoven fabric may be produced by preparing a fiber web containing the hydrophilic short fibers described above, subjecting the fiber web to fiber entangling treatment such as the hydroentangling treatment, and then drying the fiber web, and if necessary, by thermally adhering the fibers with each other by the low-melting point component contained in such fibers, for example.

The fiber web is prepared by mixing constituent fibers. A form of the fiber web may be in any form selected from a parallel web, a cross web, a carded web such as a semi-random web and a random web, an air-laid web, a wet paper-making web, and a spun-bond web. The hydroentangling treatment is applied thereto by placing the fiber web on a support and jetting a columnar water flow.

The ultrafine fiber layer and the hydrophilic short fiber layer can also be separately produced, and in a step of preparing the ultrafine fiber layer by the melt-blown method, the melt-blown nonwoven fabric is also preferably laminated directly onto the spunlace nonwoven fabric by inserting the spunlace nonwoven fabric prepared in advance thereinto.

Next, the ultrafine fiber layer and the hydrophilic short fiber layer are united. Examples of a laminating means include a method using a heating roll, and also a heating oven system, a needle punch system, a spunlace system (hydroentangling system), a method by ultrasonic wave, and a method using an adhesive. A means of composite formation in the production according to the invention is not particularly limited, but the composite is preferably formed by using a heating roll (hereinafter, referred to as a “heating embossing roll” in several cases) in which a roll surface is engraved into an uneven shape. Partial thermocompression bonding using an embossing roll is preferably performed by performing compression-bonding of the heating embossing roll onto a surface on a side of the hydrophilic short fiber layer. At this time, the partial thermocompression bonding is performed in contact of the other surface of the laminated nonwoven fabric with a roll having a surface engraved in a smooth shape or the uneven shape or the like. The roll is also preferably heated.

On the surface of the laminated nonwoven fabric sheet of the invention, discontinuous and regular concave portions resulting from the partial thermocompression bonding are formed. Such concave portions may be formed on both surfaces or only on one surface of the laminated nonwoven fabric sheet.

The laminated nonwoven fabric sheet is bonded, in the sheet thickness direction in a site in which the concave portion exists, at least with the fibers constituting the hydrophilic short fiber layer by softening of the elastomer fibers in the ultrafine fibers, whereby the hydrophilic short fiber layer and the ultrafine fiber layer are united. A pressure and a temperature of the thermocompression bonding can be appropriately selected under such conditions that the hydrophilic short fiber layer and the ultrafine fiber layer are united by softening of the elastomer fibers in the ultrafine fibers, in which a linear pressure of partial thermocompression bonding is preferably in the range of 5 to 100 N/mm, a temperature of thermocompression bonding is preferably a temperature equal to or higher than the melting point or softening point of elastomer resin (B), and equal to or lower than the softening point of thermoplastic resin (A), and the pressure and the temperature are not particularly limited as long as the pressure and the temperature are in the range in which the bonding is formed between the ultrafine fiber layer and the hydrophilic short fiber layer, thereby obtaining interlayer strength.

Electret processing can be performed by a publicly-known device or under publicly-known conditions, and a specific method is not particularly limited, and a thermal electret method, a corona discharge method or the like can be used, for example.

When the laminated nonwoven fabric sheet of the invention is used in the mask, the laminated nonwoven fabric sheet produced by the method is subjected to various posttreatment processing, washing, drying or the like, when necessary, and then cut into a predetermined size. Moreover, pleating or formation may be performed. In the pleating, a fold part of a folded nonwoven fabric sheet or an edge or the like of a cut portion may be thermally pressed to cause thermocompression bonding. Moreover, simultaneously or as a separate step, ear-fitting portions and other parts can be thermally compression-bonded, and united.

The laminated nonwoven fabric sheet of the invention can be preferably used for the mask such as a medical mask, an industrial mask, and a general purpose mask. Moreover, the laminated nonwoven fabric sheet of the invention can be processed into an HEPA filter to be used in an air conditioner and air-conditioning facilities depending on adaptation with required performance. The laminated nonwoven fabric sheet of the invention is also preferably subjected to pleating and used for the applications described above.

### EXAMPLES

Examples described below are merely for illustrative purposes. A scope of the invention is not limited to the present Examples. In addition, measuring methods or definitions with regard to values of physical properties shown in Examples are also described below.

### Filter Performance (Collection Performance and Pressure Loss)

Collection efficiency and pressure loss of a mask were measured by using TSI 8130 type Filter Tester. Collection efficiency of a sheet was measured by passing air containing NaCl aerosol (mean particle size: 0.3 μm) generated by the same Tester through a testing sheet. Moreover, pressure loss thereof on the above occasion was measured. An air flow rate at this time was adjusted to 85 L/min (measuring area: 100 cm²).

### Mean Fiber Diameter

An enlarged photograph of a nonwoven fabric surface was photographed by using a scanning electron microscope (SEM), and diameters of 100 fibers were measured, and an arithmetic mean value was taken as a mean fiber diameter.

### Compression-Bonded Area Percentage

An enlarged photograph of a nonwoven fabric surface was photographed by using a scanning electron microscope (SEM), and a proportion of an area per unit compression-bonded point pitch was taken as a compression-bonded area percentage.

Compression-bonded area percentage (%)=(compression-bonded point area occupying unit pitch/unit pitch area)×100

### Stretch Strength of Laminated Sheet

Stretch strength was measured in accordance with JIS L1906 “Test methods for non-woven fabrics made of filament yarn.” A test piece having a width of //25 mm and a length of 200 mm was prepared. As the test pieces, two kinds of test pieces were arranged: a material prepared by being cut from a laminated sheet in such a manner that a length direction of the test piece coincides with a CD direction of a spunlace nonwoven fabric in a hydrophilic short fiber layer (a direction perpendicular to alignment of fibers in the nonwoven fabric), and a material prepared in such a manner that a length direction of the test piece coincides with an MD direction of the spunlace nonwoven fabric in the hydrophilic short fiber layer (a direction in which the fibers are aligned in an identical direction in the nonwoven fabric).

The test piece was fixed by setting an interchuck distance to 100 mm using Tensile Testing Machine Autograph AG-G (trade name, made by Shimadzu Corporation). The test piece was stretched at a tensile speed of 300 mm per minute. Moreover, strength at 10% or 50% stretch was taken as strength of stretch modulus (stress).

### Heat Resistance Stability (Heat Treatment at 100° C.)

A sheet after electret processing was allowed to stand for 10 minutes under an atmosphere of 100° C. by using a convention oven (model: MOV-112F made by SANYO), the resulting sheet was taken out, and cooled for 10 minutes, and then filter performance was measured.

Materials described below were used in Examples and Comparative Examples.

### Ultrafine Fiber Layer

Polypropylene resin (melting point: 166° C., polypropylene homopolymer, MFR=82 (JIS K-7210 (1999) 230° C./10 min)
Elastomer resin (melting point: 100° C., polyethylene-based elastomer, “ENGAGE 8402” made by The Dow Chemical Company, MFR=30 (JIS K-7210 (1999) 190° C./10 min)
Hindered amine-based compound (“Chimassorb 944 FDL” made by BASF Japan Ltd.)

### Hydrophilic Short Fiber Layer

Rayon/PET (mass ratio: 60/40%) spunlace nonwoven fabric (basis weight: 38 g/m², fiber length: 51 mm, made by ZUIKO Corporation)

### Example 1

As a raw material of an ultrafine fiber layer, a blended material of polypropylene (99.5% by mass) as thermoplastic resin (A) and Chimassorb 944 FDL (0.5% by mass) being a hindered amine compound was used, and a polyethylene-based elastomer was used as thermoplastic resin (B). A melt-blown nonwoven fabric was produced by using a nonwoven fabric production apparatus formed of two extruders each having a screw (diameter: 50 mm), a heating element and a gear pump, a combining spinneret (pore diameter: 0.3 mm, 501 holes were aligned in one row, different component fibers were alternately aligned, effective width: 500 mm), a compressed air generator, an air heater, a collection conveyor having a polyester net, and a winder.

A raw material resin was put in each extruder, and thermoplastic resin (A) was heated and melted at 230° C., and thermoplastic resin (B) was heated and melted at 230° C., the gear pump was set to be 50/50% in a mass ratio of thermoplastic resin (A) to thermoplastic resin (B), the resulting melted resin was output from the spinneret at a rate of 0.3 g/min per one hole, and the output fibers were blown onto the polyester conveyor set at a distance of 30 cm from the spinneret by compressed air having 98 kPa (gauge pressure) and heated to 400° C. to arbitrarily set a basis weight by adjusting a speed of the collection conveyor.

In a process of producing the melt-blown nonwoven fabric according to the method described above, as a hydrophilic short fiber layer, such a spunlace nonwoven fabric was inserted thereinto as the fabric having a basis weight of 38 g/m², and composed of rayon/polyester (combined fibers having a mass ratio: 60/40) including rayon having a fiber length of 51 mm, and polyester having a fiber length of 51 mm, and having stretchability in a direction perpendicular to the direction in which fibers were aligned in one direction to laminate a melt-blown nonwoven fabric having 30 g/m² thereon. Further, a point bond processor having an embossing (engraved) roll engraved with an uneven pattern on a surface thereof and a flat (smooth) roll was used for a laminate of the nonwoven fabrics to pass the laminate between the embossing roll having a compression-bonded area percentage of 4.0% in an embossing convex portion and the flat roll described above in such a manner that the embossing roll was in contact with the spunlace nonwoven fabric at a temperature of 80/120° C. and a linear pressure of 40 N/mm to obtain a laminated sheet.

The resulting laminated sheet was subjected to electret processing by using a thermal electret method. Electret processing was performed by cutting the laminated sheet into a material having an A4 size, placing the resulting material on a charge receiving table heated to 100° C., placing a charged electrode plate on 1 cm above the laminated sheet, leaving the resulting material to stand for 10 minutes, and then applying voltage at a voltage of −10 kV for a charging time of 5 seconds.

### Comparative Example 1

A laminated nonwoven fabric sheet was prepared in a manner similar to Example 1 except that no electret processing was performed.

### Comparative Example 2

A laminated nonwoven fabric sheet was prepared in a manner similar to Example 1 except that no hindered amine-based was contained therein.

### Comparative Example 3

A laminated nonwoven fabric sheet was prepared in a manner similar to Example 1 except that an ultrafine fiber layer was formed only of polyethylene-based elastomer resin (B) and no electret processing was performed.

### Comparative Example 4

A laminated nonwoven fabric sheet was prepared in a manner similar to Example 1 except that an ultrafine fiber layer was formed only of polyethylene-based elastomer resin (B).

### Comparative Example 5

A laminated nonwoven fabric sheet was prepared in a manner similar to Example 1 except that an ultrafine fiber layer was formed only of thermoplastic resin (A) containing polypropylene (99.5% by mass) and Chimassorb 944 FDL (0.5% by mass).

Table 1 shows evaluation results of the laminated nonwoven fabric sheets in Example 1 and Comparative Examples 1 to 5.

TABLE 1

| | | | | | | | | | Heat | | | |
|---|---|---|---|---|---|---|---|---|---|---|---|---|
| | Ultrafine fiber layer | | | | | Compression- | | | resistance | Stretch strength | | |
| | Resin A | Resin B | Hindered | | Electret | bonded | Filter performance | | stability | CD | CD | MD |
| | (fiber | (fiber | amine | hydrophilic | Presence | area | Collection | Pressure | Collection | 10% | 50% | 10% |
| | diameter | diameter | Presence | short | or | percentage | efficiency | loss | efficiency | N/25 | N/25 | N/25 |
| | μm) | μm) | or absence | fiber layer | absence | (%) | % | Pa | % | mm | mm | mm |
| Example 1 | PP 2 | Elastomer | Presence | Rayon/ | Presence | 4.0 | 90 | 40 | 90 | 1.1 | 3.7 | 20.0 |
| | μm | 18 μm | | PET SL | | | | | | | | |
| Comparative | PP 2 | Elastomer | Presence | Rayon/ | Absence | 4.0 | 45 | 38 | 40 | 1.0 | 3.3 | 18.0 |
| Example 1 | μm | 18 μm | | PET SL | | | | | | | | |
| Comparative | PP 2 | Elastomer | Absence | Rayon/ | Presence | 4.0 | 83 | 40 | 75 | 1.2 | 3.8 | 21.0 |
| Example 2 | μm | 18 μm | | PET SL | | | | | | | | |
| Comparative | Elastomer | Elastomer | Absence | Rayon/ | Absence | 4.0 | 12 | 30 | 10 | 0.7 | 3.0 | 17.0 |
| Example 3 | 18 μm | 18 μm | | PET SL | | | | | | | | |
| Comparative | Elastomer | Elastomer | Presence | Rayon/ | Presence | 4.0 | 25 | 32 | 18 | 1.0 | 3.0 | 17.0 |
| Example 4 | 18 μm | 18 μm | | PET SL | | | | | | | | |
| Comparative | PP 2 | PP 2 | Presence | Rayon/ | Presence | 4.0 | 98 | 55 | 98 | 4.0 | 10.0 | 25.0 |
| Example 5 | μm | μm | | PET SL | | | | | | | | |

As shown in Table 1, the laminated nonwoven fabric sheet in Example 1 had high collection efficiency and low pressure loss, and had low stretch strength in the CD direction, high stretch strength in the MD direction, namely, high stretchability in the CD direction. On the other hand, in Comparative Example 1 in which no electret processing was performed, the collection efficiency was insufficient. In Comparative Example 2 in which no hindered amine was contained, the collection efficiency was insufficient even when electret processing was performed, and the sheet lacked in the heat resistance stability. In Comparative Examples 3 and 4 in which the ultrafine fiber layers were formed only of the elastomers, the collection efficiency was insufficient, regardless of presence or absence of the hindered amine and electret processing. Moreover, in Comparative Example 5 in which the ultrafine fiber layer was formed only of PP, the collection efficiency was sufficient, but the stretch strength was high in both the CD direction and the MD direction, and texture was hard, and fitting performance was insufficient.

### INDUSTRIAL APPLICABILITY

A laminated nonwoven fabric sheet of the invention can be preferably used as a filter material for a medical mask, an industrial mask, a general purpose mask or the like. Moreover, the laminated nonwoven fabric sheet of the invention can also be used as a high performance air filter used for a clean room, an air cleaner, a home appliance or the like.

1. A laminated nonwoven fabric sheet formed by uniting an ultrafine fiber layer and a hydrophilic short fiber layer, wherein
the hydrophilic short fiber layer is laminated on one surface or both surfaces of the ultrafine fiber layer;
the ultrafine fiber layer is formed by combining 20 to 80% by mass of thermoplastic resin fibers (A) and 80 to 20% by mass of elastomer resin fibers (B) that melt or soften at a temperature lower than a temperature of thermoplastic resin fibers (A); and the ultrafine fiber layer comprises a hindered amine compound;
the laminated nonwoven fabric sheet is subjected to electret processing; and
10% stretch strength in one direction is different from 10% stretch strength in a direction perpendicular to the one direction.

2. The laminated nonwoven fabric sheet according to claim 1, wherein the ultrafine fiber layer and the hydrophilic short fiber layer are united by partial thermocompression bonding, 10% stretch strength in one direction is 3 N/25 mm or less and 50% stretch strength is 10 N/25 mm or less, and 10% stretch strength in a direction perpendicular to the one direction is 15 N/25 mm or more.

3. The laminated nonwoven fabric sheet according to claim 1, wherein discontinuous and regular concave portions are formed on a surface of the laminated nonwoven fabric sheet, and a total area of the concave portions on the surface is in the range of 3 to 40%; and
in a sheet thickness direction of the concave portions, the elastomer resin fibers (B) in the ultrafine fiber layer and fibers constituting the hydrophilic short fiber layer are bonded; and the hydrophilic short fiber layer and the ultrafine fiber layer are united.

4. The laminated nonwoven fabric sheet according to claim 1, wherein the hydrophilic short fiber layer is a layer comprising at least 30% by mass of short fibers of cotton, rayon, cupra, pulp, or two or more kinds thereof.

5. The laminated nonwoven fabric sheet according to claim 1, wherein the hydrophilic short fiber layer is a spunlace nonwoven fabric or a wet paper-making web.

6. The laminated nonwoven fabric sheet according to claim 1, wherein the ultrafine fiber layer is a melt-blown nonwoven fabric formed by randomly accumulating long fibers.

7. A mask, comprising the laminated nonwoven fabric sheet according to claim 1.

8. The laminated nonwoven fabric sheet according to claim 2, wherein discontinuous and regular concave portions are formed on a surface of the laminated nonwoven fabric sheet, and a total area of the concave portions on the surface is in the range of 3 to 40%; and
in a sheet thickness direction of the concave portions, the elastomer resin fibers (B) in the ultrafine fiber layer and fibers constituting the hydrophilic short fiber layer are bonded; and the hydrophilic short fiber layer and the ultrafine fiber layer are united.

9. The laminated nonwoven fabric sheet according to claim 2, wherein the hydrophilic short fiber layer is a layer comprising at least 30% by mass of short fibers of cotton, rayon, cupra, pulp, or two or more kinds thereof.

10. The laminated nonwoven fabric sheet according to claim 3, wherein the hydrophilic short fiber layer is a layer comprising at least 30% by mass of short fibers of cotton, rayon, cupra, pulp, or two or more kinds thereof.

11. The laminated nonwoven fabric sheet according to claim 8, wherein the hydrophilic short fiber layer is a layer comprising at least 30% by mass of short fibers of cotton, rayon, cupra, pulp, or two or more kinds thereof.

12. The laminated nonwoven fabric sheet according to claim 2, wherein the hydrophilic short fiber layer is a spunlace nonwoven fabric or a wet paper-making web.

13. The laminated nonwoven fabric sheet according to claim 3, wherein the hydrophilic short fiber layer is a spunlace nonwoven fabric or a wet paper-making web.

14. The laminated nonwoven fabric sheet according to claim 4, wherein the hydrophilic short fiber layer is a spunlace nonwoven fabric or a wet paper-making web.

15. The laminated nonwoven fabric sheet according to claim 8, wherein the hydrophilic short fiber layer is a spunlace nonwoven fabric or a wet paper-making web.

16. The laminated nonwoven fabric sheet according to claim 2, wherein the ultrafine fiber layer is a melt-blown nonwoven fabric formed by randomly accumulating long fibers.

17. The laminated nonwoven fabric sheet according to claim 3, wherein the ultrafine fiber layer is a melt-blown nonwoven fabric formed by randomly accumulating long fibers.

18. The laminated nonwoven fabric sheet according to claim 4, wherein the ultrafine fiber layer is a melt-blown nonwoven fabric formed by randomly accumulating long fibers.

19. The laminated nonwoven fabric sheet according to claim 5, wherein the ultrafine fiber layer is a melt-blown nonwoven fabric formed by randomly accumulating long fibers.

20. The laminated nonwoven fabric sheet according to claim 8, wherein the ultrafine fiber layer is a melt-blown nonwoven fabric formed by randomly accumulating long fibers.
